(19) United States
(12) Patent Application Publication
(10) Pub. No.: US 2010/0250294 A1
(43) Pub. Date: Sep. 30, 2010

(54) TECHNICAL FEASIBILITY EXPLORATION FOR SERVICE-ORIENTED ARCHITECTURE ENVIRONMENTS

(75) Inventors: Abdul Allam, Raleigh, NC (US); Ramnath Kumaresan, Cerritos, CA (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/410,493

(22) Filed: Mar. 25, 2009

(51) Int. Cl. G06F 15/18; G06Q 10/00

(52) U.S. Cl. 705/7; 706/12

(57) ABSTRACT

Methods, including service methods, articles of manufacture, systems, articles and programmable devices are provided for performing a technical feasibility exploration for a service-oriented architecture. A challenge associated with enabling a service-oriented architecture service is identified, and an impact of the challenge identified and analyzed. A potential solution of the identified challenge is identified as a function of analyzing the impact and analyzed to determine if a new challenge associated with enabling a service-oriented architecture service arises as a function of the potential solution. If determined that a new challenge arises, challenge identifying, challenge impact identifying and analyzing, potential solution identifying and the analyzing is repeated. If analyzing determines that a new challenge does not arise, a potential solution is used as an input during an implementation phase.

### FIELD OF THE INVENTION

The present invention generally describes methods, systems and devices for Technical Feasibility Exploration (TFE) techniques in a service-oriented architecture.

### BACKGROUND OF THE INVENTION

Current Technical Feasibility Exploration (TFE) techniques are designed to focus on application developments, and generally focus on a specific problem and address a potential solution in the context of a specific challenge or problem. More particularly, the focus of TFE is normally on a specific application, and a TFE is performed in the context of a silo'ed application focus, which may involve middleware components, adapters, and other relevant supporting infrastructure components.

A Service-Oriented Architecture (SOA) environment is a business-centric information technology (IT) architectural approach that supports integrating linked and repeatable business tasks or services, services are designed and created leveraging functionality/capability from across applications which can be from same or different business domains. Realization decisions for SOA services that can be re-used across lines of business and channels in a consistent manner are not simple. There are potential risks, especially with respect to performance of a given service as there is interdependency not only upon performance or capabilities of other applications but all upon also the performance of various supporting middleware and infrastructure components. Current TFE techniques are deficient in meeting the needs of service enablement, design and development, within an SOA orientation.

### SUMMARY OF THE INVENTION

Methods are provided for performing a technical feasibility exploration for a service-oriented architecture. A challenge associated with enabling a service-oriented architecture service is identified, and an impact of the challenge identified and analyzed. A potential solution of the identified challenge is identified as a function of analyzing the impact and analyzed to determine if a new challenge associated with enabling a service-oriented architecture service arises as a function of the potential solution. If determined that a new challenge arises, challenge identifying, challenge impact identifying and analyzing, potential solution identifying and the analyzing is repeated. If analyzing determines that a new challenge does not arise, a potential solution is used as an input during an implementation phase. Further, at least one of said identifying the challenge, identifying and analyzing the impact of the challenge, identifying the potential solution and analyzing the potential solution are performed by a programmable device configured by a logic component.

Some methods further comprise performing challenge identifying, impact of the challenge identifying and analyzing, potential solution identifying and analyzing the potential solution to determine if a new challenge arises as a function of a service-oriented architecture architectural principle, a functional requirement, a nonfunctional requirement and at least one service-oriented architecture aspect selected from the group consisting of a business goal, an architectural decision, a design/architectural pattern, a service dependency, a service choreography, a message specification, a message transformation, a state management, a cost effectiveness, and an existing asset analysis.

Service methods are also provided comprising deploying programmable devices or logic components or applications for performing a technical feasibility exploration for a service-oriented architecture according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for performing a technical feasibility exploration for a service-oriented architecture. Moreover, systems, articles and programmable devices are also provided, configured for performing one or more method and/or process elements of the current invention for performing a technical feasibility exploration for a service-oriented architecture, for example as described above.

### BRIEF DESCRIPTION OF THE DRAWINGS

These and other features of the methods, systems and devices according to the present application will be more readily understood from the following detailed description of the various aspects of the embodiments taken in conjunction with the accompanying drawings in which:

FIG. 1 is a flow chart illustrating a prior art technical feasibility exploration.

FIG. 2 is a flow chart illustrating a method and system for performing a technical feasibility exploration for a service-oriented architecture according to the present invention.

FIG. 3 is a tabular illustration of an application of a method and system for performing a technical feasibility exploration for a service-oriented architecture according to the present invention.

FIG. 4 is a block diagram of a system or device configured perform a technical feasibility exploration for a service-oriented architecture according to the present invention.

FIG. 5 is a block diagram illustrating a computerized implementation of a method and system for calibrating and customizing an estimation model as a function of an SOA environment according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description; and

II. Computerized Implementation.

### I. General Description

Examples of SOA aspects and governance processes according to the present invention may be found in the following commonly-owned and co-pending U.S. patent applications or issued U.S. patents, the disclosures of which are expressly incorporated herein by reference: “Identifying a Service Oriented Architecture Shared Services Project”, attorney docket no. END920080252US1, filed on (to be provided), and assigned application serial no. (to be provided); “Evaluating a Service Oriented Architecture Shared Services Project”, attorney docket no. END920080288US1, filed on (to be provided), and assigned application serial no. (to be provided); “Service Oriented Architecture Shared Service Inception”, attorney docket no. END920080289US1, filed on (to be provided), and assigned application serial no. (to be provided); “Service Oriented Architecture Shared Services Elaboration”, attorney docket no. END920080290US1, filed on (to be provided), and assigned application serial no. (to be provided); “Service Oriented Architecture Shared Services Construction”, attorney docket no. END920080291US1, filed on (to be provided), and assigned application serial no. (to be provided); “Transitioning to Management of a Service Oriented Architecture Shared Service”, attorney docket no. END920080292US1, filed on (to be provided), and assigned application serial no. (to be provided); “Service Oriented Architecture Shared Service Management”, attorney docket no. END920080293US1, filed on (to be provided), and assigned application serial no. (to be provided); “Service Oriented Architecture Shared Service Escalation”, attorney docket no. END920080294US1, filed on (to be provided), and was assigned application serial no. (to be provided); “SOA POLICY VERSIONING”, attorney docket no. END920080316US1-IEN106616, filed on (to be provided), and assigned application serial no. (to be provided); “FRAMEWORK FOR VARIATION ORIENTED ANALYSIS FOR SERVICE-ORIENTED ARCHITECTURE”, attorney docket no. END920080317US1-IEN106617, filed on (to be provided), and assigned application serial no. (to be provided); “SOA LIFECYCLE GOVERNANCE AND MANAGEMENT”, attorney docket no. END920080319US1-IEN106619, filed on (to be provided), and assigned application serial no. (to be provided); “ENABLING SOA GOVERNANCE USING A SERVICE LIFECYCLE APPROACH”, attorney docket no. END920080320US1-IEN106620, filed on (to be provided), and assigned application serial no. (to be provided); “CALIBRATION FRAMEWORK FOR EFFORT ESTIMATION”, attorney docket no. END920080321US1-IEN106621, filed on (to be provided), and assigned application serial no. (to be provided); “SERVICE PORTFOLIO APPROACH FOR SOA GOVERNANCE”, attorney docket no. END920080386US1-IEN106642, filed on (to be provided), and assigned application serial no. (to be provided); “SERVICE EVOLUTION APPROACH IN SOA”, attorney docket no. END920080387US1-IEN106643, filed on (to be provided), and assigned application serial no. (to be provided); “CAPABILITY AND MATURITY-BASED SOA GOVERNANCE”, attorney docket no. END920080388US1-IEN106644, filed on (to be provided), and assigned application serial no. (to be provided); “PRIORITIZATION ENABLEMENT FOR SOA GOVERNANCE”, attorney docket no. END920080389US1-IEN106645, filed on (to be provided), and assigned application serial no. (to be provided); and “SOA POLICY ENGINE FRAMEWORK”, attorney docket no. END920080390US1-IEN106646, filed on (to be provided), and assigned application serial no. (to be provided).

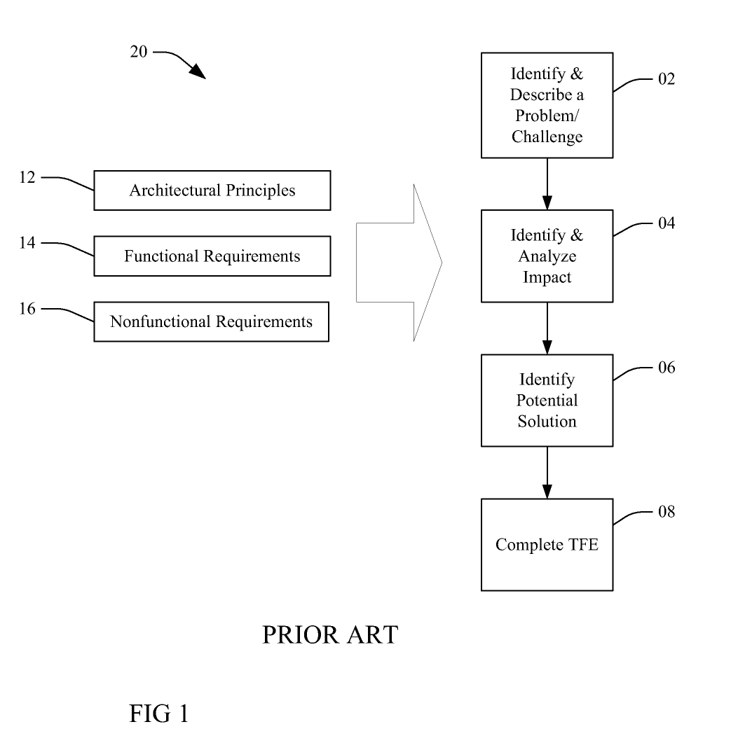

FIG. 1 is an illustration of a prior art TFE model 20 wherein at 02 a problem or challenge is identified and described, at 04 an impact is identified and analyzed, and at 06 a potential solution is identified for a specific problem or to address a potential solution in the context of a specific challenge or problem, and the TFE solution is implemented at 08, and wherein each of the processes 02-04-06-08 is a function of one or more architectural principles 12, functional requirements 14 and nonfunctional requirements 16. More particularly, the focus of the prior art TFE model 20 is on a specific application, and the TFE processes 02-04-06-08 performed in the context of a silo'ed application focus involving middleware components, adapters, and other relevant supporting infrastructure components as articulated within the architectural principles 12, functional requirements 14 and nonfunctional requirements 16 specific to a particular application, challenge or problem.

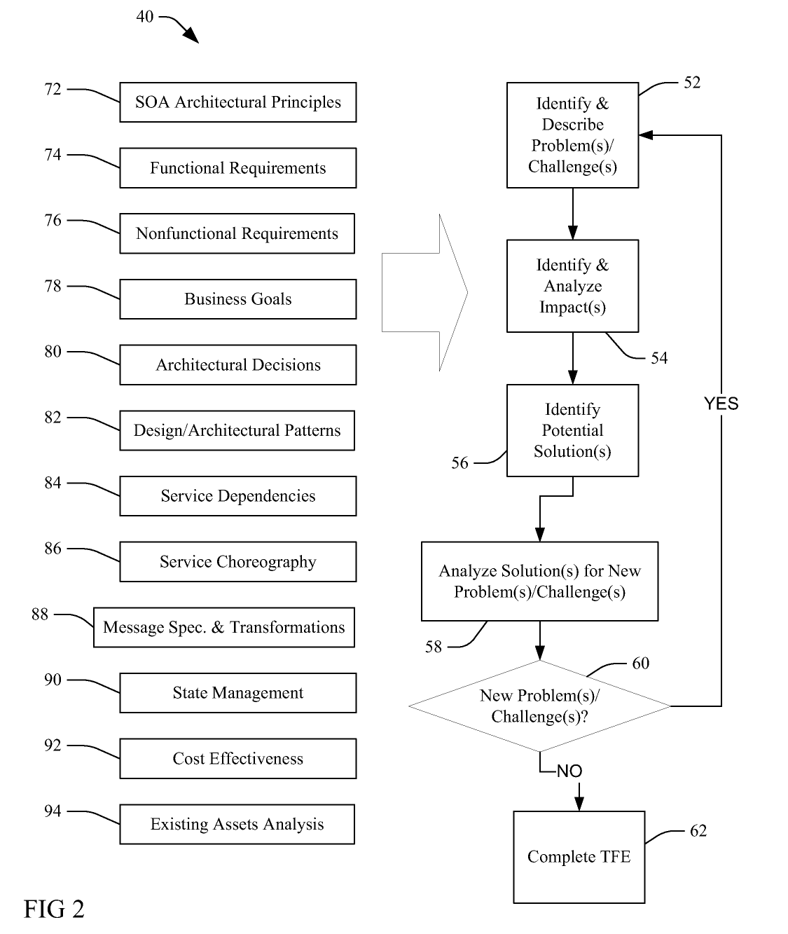

FIG. 2 illustrates a Technical Feasibility Exploration (TFE) model or framework 40 for a service-oriented architecture (SOA) according to the present invention. In one aspect the present SOA-TFE model 40 takes into consideration services flows and other aspects 72 through 94 of SOA orientation not considered by prior art TFE models. Thus the model 40 performs processes 52-54-56-58-60-62 as a function of SOA architectural principles 72, functional requirements 74 and nonfunctional requirements 76, as well as of Business Goals 78, Architectural Decisions 80, Design/Architectural Patterns 82, Service Dependencies 84, Service Choreography 86, Message Specifications (“Spec.”) & Transformations 88, State Management 90, Cost Effectiveness 92 and Existing Assets Analysis 94.

Within an SOA environment often a potential solution to a problem may lead to new challenges/new problems. Thus, the SOA-TFE model 40 provides for continuing or additional analysis process until each main and sub-challenge is addressed. More particularly, after the processes of identifying and describing one or more problems or challenges associated with enabling a service-oriented architecture service at 52, identifying and analyzing one or more impacts of the problem(s)/challenge(s) at 54 and responsively identifying one or more potential solutions at 56, at 58 the present invention further analyzes the potential solution(s) to determine if the potential solution causes a new challenge associated with enabling a service-oriented architecture and for any new problems or challenges associated therewith. If analyzing the potential solution(s) results in a determination at 60 that a new problem/challenge does in fact arise from the pending potential solution(s), then the process loops back again through the identifying/describing of problems/challenges at 52, the identifying/analyzing of impacts at 54, the responsively identifying potential solutions at 56, the analyzing potential solutions at 58 and the determining occurrences of new problems/challenges from the potential/proposed solutions at 60 until no further new problems are determined at 60, wherein the TFE is completed at 62 (e.g. by using the one or more potential/proposed solutions as input during an Implementation phase).

The present SOA-TFE model 40 thus helps reduce risks and development time, thereby increasing productivity during an S OA implementation phase. In another aspect, the present invention focuses on services, with key inputs from one or more of the 72 through 94 to the model 40 comprising information gathered during Services Identification and Specification phases of the architectural decisions 80 of an SOA Service Modeling process; in one embodiment, key SOA orientation aspect inputs used for this analysis include business goal modeling 78, existing asset analysis (e.g. for reuse) 94, nonfunctional requirements 76, service choreography (e.g. composition and service flows) 86, service dependencies 84, and state management (e.g. service component specifications) 90.

Analyzing a proposed solution at 58 may further comprise determining what enhancements need to be done to service flows, granularity and specific patterns and other choreography aspects 86 or message specifications 88 in order to meet business goals 78 and nonfunctional requirements 76. The present SOA-TFE model 40 thus helps mitigate risk during a Service Implementation Phase and also provide valuable input as to how to re-factor a service or existing asset to meet a performance requirement. It will also be understood that though the present SOA-TFE model 40 focuses on services, embodiments of the present invention may also be applied to any application development.

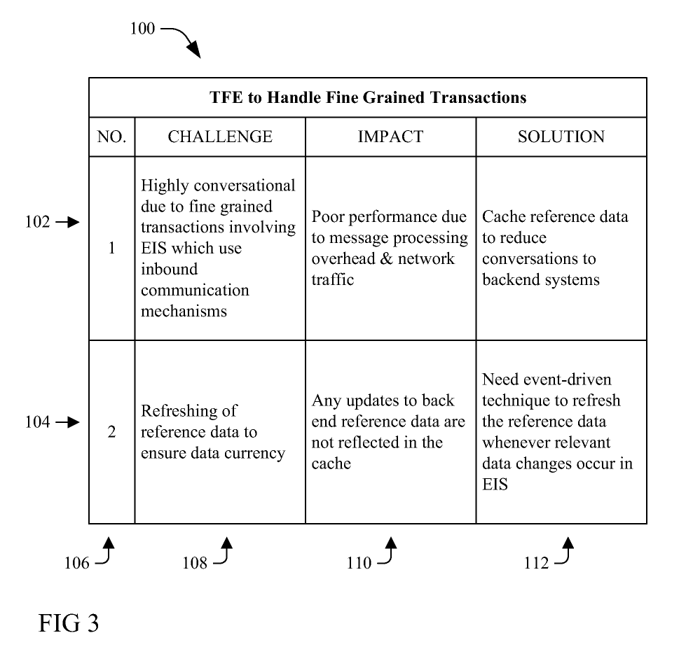

FIG. 3 provides a tabular illustration 100 of an application of the SOA-TFE model 40 to provide a TFE to handle fine grained transactions to a back-end system which impact performance due to a conversational nature. Thus, each of first and second rows of entries 102/104 comprise first and second steps/iterations of the processes of the SOA-TFE model 40 wherein a first column 106 identifies a step number corresponding to each iteration, a second column 108 listing the challenges or sub challenges for a given iteration, a third column 110 listing the impacts associated with each challenge and the fourth column 112 documenting feasible solutions.

Thus is a first iteration or step 102, identified as No. 1 in column 106, the challenge column 108 identifies and explains the nature of a challenge associated with enabling a service which consists of multiple fine grained transactions to an enterprise information system (EIS). In the present example scenario, a middleware has to interact with the EIS multiple times using different messages, presenting a highly-conversational challenge due to fine-grained transactions involving the EIS which use inbound communication mechanisms. This would mean multiple specifications—one for each sub message for each fine grained transaction. The results from these sub messages must be collected and aggregated as the response to the service request. Thus, the impact indicated in the corresponding first step 102 impact column 110 of these fine grained transactions is poor performance due to increased message processing overhead and network traffic, which will also have impact on a response time nonfunctional requirement. In order to identify a potential solution, detailed analysis of existing assets is performed through the SOA-TFE model 40 to understand the business logic and mediation capabilities supported by middleware components. Data collected during identification and specification phases of service modeling provides a source of useful information for this analysis. Thus, the solutions column 112 for the first step 102 shows a potential solution determined for each of the corresponding first step 102 challenges 108: to cache reference data to reduce conversations to backend systems.

However, this solution leads to additional challenges. For instance, although caching of reference data may reduce conversations to back-end system (thereby solving the first step 102 challenge 108), data in the back-end systems may change and if that happens the cached data would be out of sync with the reference data, resulting in a service serving old information. More particularly, analysis of the first step 102 solution 112 (at 58, FIG. 2) of the SOA-TFE model 40 comprises revisiting analysis of existing assets 94, service composition & flow 86, nonfunctional requirements 76, component specification 90 and service interface specifications (dependencies) 84 to analyze and identify impacts, wherein the focus in the present analysis is to analyze various aspects such as the frequency of updates to back end reference data, the importance and business need to serve the updated information etc., in order to analyze the real impact of the challenge.

Thus, the existence of a new challenge is recognized (at 60, FIG. 2) and identified (at 52, FIG. 2) and entered as the second step 102, No. 2 at 106, challenge 108: a need to keep cache refreshed and current, namely refreshing of reference data to ensure data currency. This is analyzed for any impact (at 54, FIG. 2), resulting in recognizing a second step 104 impact entry 110 that any updates to back end reference data are not reflected in the cache.

Using available patterns and best practices, the present example identifies a second step 104 potential solution 112 for this challenge (at 56, FIG. 2); a need for an event-driven technique to refresh the reference data whenever relevant data changes occur in EIS. More particularly, information collected during the service composition & flow aspect 86 of a service specification phase shows that it is possible to implement an industry-known best practice of an event-driven technique to refresh the cache whenever relevant data changes occur in EIS.

Thus, the processes of the first step 102 and the second step 104 may be repeated until all challenges are resolved, wherein the process moves forward to an implementation phase. For example, in one embodiment, analysis of a current EIS environment may indicate that the second step 104 event-driven mechanism solution 112 is not supported, wherein a further, subsequent third, etc. step exploration/analysis on this newly identified challenge is preformed, etc.; thus, according to the present invention, if there are still open challenges, then it is indicated that the present solution(s) are not technically feasible solution(s), and implementation does not occur until the open challenges are resolved.

FIG. 4 illustrates a programmable device or module 200 configured to plan routes as a function of vehicle type according to the present invention, for example as illustrated in FIGS. 1-3 and described above. The device 200 may be incorporated into a larger system (such as one provided by a service provider) wherein other applications and components of the larger system accomplish systems and methods according to the present invention, or it may be a stand-alone device or module 200 configured to perform each of the systems and methods described above. The present embodiment comprises a central processing unit (CPU) or other processing means 201 in communication with a memory 203 comprising logic components (e.g. algorithms, etc.) that enable the CPU 201 to perform processes and methods according to the present application, as will be understood through reference to FIGS. 1-3 as discussed above. Thus, the memory 203 comprises a service-oriented architecture application challenge identifier logic component (e.g. algorithm, etc.) 202, a challenge impact analyzer logic component 204, a potential solution identifier logic component 206 and a potential solution analyzer logic component 208 configured to analyzing a potential solution to determine if the potential solution causes a new challenge associated with enabling a service-oriented architecture service. However, it will be understood that in other embodiments one or more of the logic components 202, 204, 206 and 208 may be omitted, and its functions or algorithms combined with others of the logic components 202, 204, 206 and 208 or accomplished by other systems, components, elements or parties.

A power source 205 is configured to provide operative power to the device 200; examples include battery units 205 and power inputs configured to receive alternating or direct current electrical power, and other appropriate power units 205 will be apparent to one skilled in the art. A communication port or network link/node means (“com port”) 207 is also provided and configured to enable data and other communications as may be appropriate, for example as discussed above.

### II. Computerized Implementation

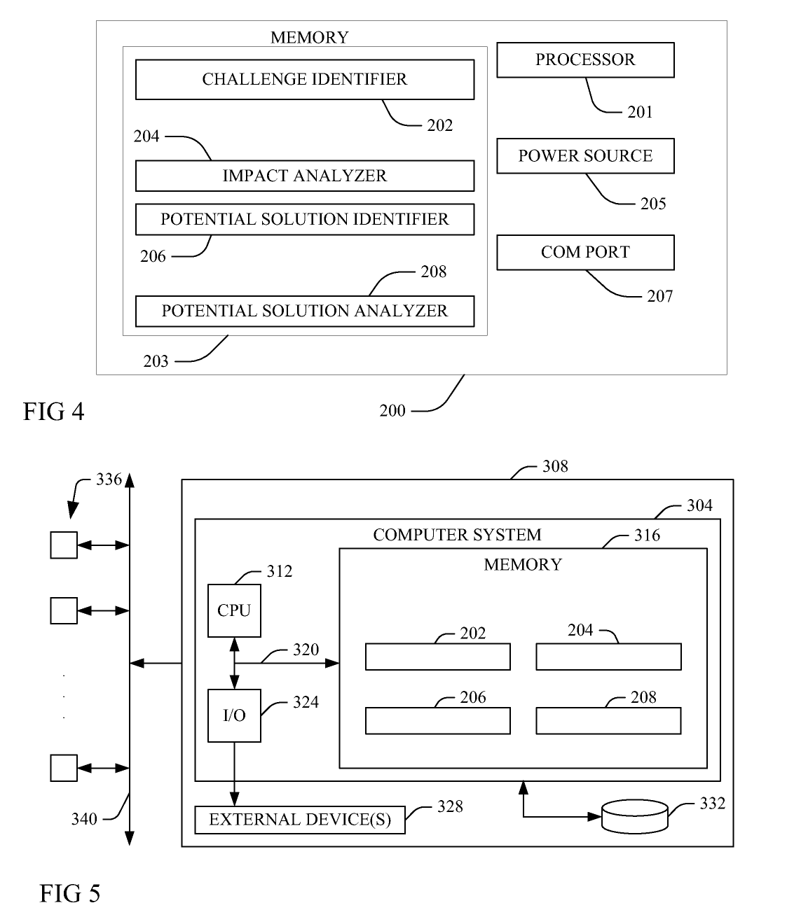

Referring now to FIG. 5, an exemplary computerized implementation of the present invention includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage media and systems 332. In general, the processing unit 312 executes computer program code, such as the code to implement various components of the process and systems, and devices as illustrated in FIGS. 1-4 and described above, including the challenge identifier 202, the challenge impact analyzer 204, the potential solution identifier 206 and the potential solution analyzer 208 discussed above, and which are stored in memory 316 and/or storage system 332. It is to be appreciated that two or more, including all, of these components may be implemented as a single component.

While executing computer program code, the processing unit 312 can read and/or write data to/from the memory 316, the storage system 332, and/or the I/O interfaces 324. The bus 320 provides a communication link between each of the components in computer system 304. The external devices 328 can comprise any devices (e.g., keyboards, pointing devices, displays, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 4 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement methods, systems and devices according to the present application, for example as illustrated in FIGS. 1-4 above and described otherwise herein. To this extent, the computer-readable/useable medium includes program code that implements each of the various process steps of the present application.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation according to the present application could be deployed, managed, serviced, etc. by a service provider who offers to implement, deploy, and/or perform the functions of the present invention for others, for example by licensing methods and browser or application server technology to an internet service provider (ISP) or a cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the present application for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the processes, methods and devices according to the present application. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 304, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

Certain examples and elements described in the present specification, including in the claims and as illustrated in the Figures, may be distinguished or otherwise identified from others by unique adjectives (e.g. a “first” element distinguished from another “second” or “third” of a plurality of elements, a “primary” distinguished from a “secondary,” an “another”, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for performing a technical feasibility exploration for a service-oriented architecture, comprising:
providing a programmable device configured by a logic component;
identifying a challenge associated with enabling a service-oriented architecture service;
identifying and analyzing an impact of the challenge;
identifying a potential solution of the identified challenge as a function of the analyzing the impact;
analyzing the potential solution to determine if a new challenge associated with enabling a service-oriented architecture service arises as a function of the potential solution;
if the analyzing the potential solution determines that the new challenge arises, repeating the challenge identifying, the impact of the challenge identifying and analyzing, the potential solution identifying and the analyzing the potential solution to determine if a new challenge arises; and
if the analyzing the potential solution determines that a new challenge does not arise, using the potential solution as an input during an implementation phase;
wherein the programmable device performs at least one of the identifying the challenge, the identifying and analyzing the impact of the challenge, the identifying the potential solution and the analyzing the potential solution as a function of the logic component.

2. The method of claim 1, further comprising performing the challenge identifying, the impact of the challenge identifying and analyzing, the potential solution identifying and the analyzing the potential solution to determine if a new challenge arises as a function of a service-oriented architecture architectural principle, a functional requirement, a nonfunctional requirement and at least one service-oriented architecture aspect selected from the group consisting of:
a business goal;
an architectural decision;
a design/architectural pattern;
a service dependency;
a service choreography;
a message specification;
a message transformation;
a state management;
a cost effectiveness; and
an existing asset analysis.

3. The method of claim 2, wherein the analyzing the potential solution to determine if the potential solution causes a new challenge associated with enabling a service-oriented architecture service is further a function of a service-oriented architecture service composition, a service-oriented architecture service component specification and a service-oriented architecture service flow.

4. The method of claim 3, wherein the analyzing the potential solution to determine if a new challenge associated with enabling a service-oriented architecture service arises further comprises using available patterns and best practices.

5. The method of claim 4, wherein the analyzing the potential solution to determine if a new challenge associated with enabling a service-oriented architecture service arises further comprises understanding a business logic and a mediation capability supported by a middleware component.

6. The method of claim 2, further comprising a service provider providing at least one of the programmable device and the logic component.

7. The method of claim 6, further comprising the programmable device performing the challenge identifying, the impact of the challenge identifying and analyzing, the potential solution identifying and the analyzing the potential solution to determine if a new challenge arises as a function of a service-oriented architecture architectural principle, a functional requirement, a nonfunctional requirement and at least one service-oriented architecture aspect selected from the group consisting of:
a business goal;
an architectural decision;
a design/architectural pattern;
a service dependency;
a service choreography;
a message specification;
a message transformation;
a state management;
a cost effectiveness; and
an existing asset analysis.

8. The method of claim 7, wherein the analyzing the potential solution to determine if the potential solution causes a new challenge associated with enabling a service-oriented architecture service is further a function of a service-oriented architecture service composition, a service-oriented architecture service component specification and a service-oriented architecture service flow.

9. The method of claim 8, wherein the analyzing the potential solution to determine if a new challenge associated with enabling a service-oriented architecture service arises further comprises using available patterns and best practices.

10. The method of claim 9, wherein the analyzing the potential solution to determine if a new challenge associated with enabling a service-oriented architecture service arises further comprises understanding a business logic and a mediation capability supported by a middleware component.

11. A method for performing a technical feasibility exploration for a service-oriented architecture, comprising:
producing computer executable program code;
storing the code on a computer readable medium; and
providing the program code to be deployed and executed on a computer system, the program code comprising instructions which, when executed on the computer system, cause the computer system to:
identify a challenge associated with enabling a service-oriented architecture service;
identify and analyze an impact of the challenge;
identify a potential solution of the identified challenge as a function of the analyzing the impact;
analyze the potential solution to determine if a new challenge associated with enabling a service-oriented architecture service arises as a function of the potential solution;
if the analyzing the potential solution determines that the new challenge arises, repeat the challenge identifying, the impact of the challenge identifying and analyzing, the potential solution identifying and the analyzing the potential solution to determine if a new challenge arises; and
if the analyzing the potential solution determines that a new challenge does not arise, use the potential solution as an input during an implementation phase.

12. The method of claim 11, the program code comprising instructions which, when executed on the computer system, further causes the computer system to identify the challenge, identify and analyze the impact of the challenge, identify the potential solution and analyze the potential solution to determine if a new challenge arises as a function of a service-oriented architecture architectural principle input, a functional requirement input, a nonfunctional requirement input and at least one service-oriented architecture aspect input selected from the group consisting of:
a business goal;
an architectural decision;
a design/architectural pattern;
a service dependency;
a service choreography;
a message specification;
a message transformation;
a state management;
a cost effectiveness; and
an existing asset analysis.

13. The method of claim 12, the program code comprising instructions which, when executed on the computer system, further causes the computer system to analyze the potential solution to determine if the potential solution causes a new challenge associated with enabling a service-oriented architecture service as a function of a service-oriented architecture service composition input, a service-oriented architecture service component specification input and a service-oriented architecture service flow input.

14. The method of claim 13, the program code comprising instructions which, when executed on the computer system, further causes the computer system to analyze the potential solution to determine if a new challenge associated with enabling a service-oriented architecture service arises by using at least one of an available patterns input and a best practices input.

15. The method of claim 14, the program code comprising instructions which, when executed on the computer system, further causes the computer system to analyze the potential solution to determine if a new challenge associated with enabling a service-oriented architecture service arises as a function of at least one of a middleware component business logic capability and a middleware component mediation capability.

16. A programmable device comprising:
a processing means;
a memory in communication with the processing means comprising a logic component; and
a network interface in communication with the processing means and the memory;
wherein the processing means is configured to:
identify a challenge associated with enabling a service-oriented architecture service;
identify and analyze an impact of the challenge;
identify a potential solution of the identified challenge as a function of the analyzing the impact;
analyze the potential solution to determine if a new challenge associated with enabling a service-oriented architecture service arises as a function of the potential solution;
if the analyzing the potential solution determines that the new challenge arises, repeat the challenge identifying, the impact of the challenge identifying and analyzing, the potential solution identifying and the analyzing the potential solution to determine if a new challenge arises; and
if the analyzing the potential solution determines that a new challenge does not arise, use the potential solution as an input during an implementation phase.

17. The programmable device of claim 16, wherein the processing means is further configured to identify the challenge, identify and analyze the impact of the challenge, identify the potential solution and analyze the potential solution to determine if a new challenge arises as a function of a service-oriented architecture architectural principle input, a functional requirement input, a nonfunctional requirement input and at least one service-oriented architecture aspect input selected from the group consisting of:
a business goal;
an architectural decision;
a design/architectural pattern;
a service dependency;
a service choreography;
a message specification;
a message transformation;
a state management;
a cost effectiveness; and
an existing asset analysis.

18. The programmable device of claim 17, wherein the processing means is further configured to analyze the potential solution to determine if the potential solution causes a new challenge associated with enabling a service-oriented architecture service as a function of a service-oriented architecture service composition input, a service-oriented architecture service component specification input and a service-oriented architecture service flow input.

19. The programmable device of claim 18, wherein the processing means is further configured to analyze the potential solution to determine if a new challenge associated with enabling a service-oriented architecture service arises by using at least one of an available patterns input and a best practices input.

20. The programmable device of claim 19, wherein the processing means is further configured to analyze the potential solution to determine if a new challenge associated with enabling a service-oriented architecture service arises as a function of at least one of a middleware component business logic capability and a middleware component mediation capability.
